(19) United States
(12) Patent Application Publication
(10) Pub. No.: US 2010/0230239 A1
(43) Pub. Date: Sep. 16, 2010

(54) MOVEMENT AND DISTRIBUTION ASSEMBLY, PARTICULARLY FOR PRODUCTS TO BE PACKAGED

(76) Inventor: Francesco Maria Bernardi, Bologna (IT)

Correspondence Address: Modiano & Associati, Via Meravigli 16, Milano, 20123, IT

(21) Appl. No.: 12/734,450

(22) PCT Filed: Oct. 16, 2008
(86) PCT No.: PCT/EP2008/063944

§ 371 Date: May 3, 2010

(30) Foreign Application Priority Data
Nov. 5, 2007 (IT) BO2007A000733

(51) Int. Cl. B65B 35/50; B65B 25/14; B65B 35/30; B65G 57/00

(52) U.S. Cl. 198/418.4

(57) ABSTRACT

A movement and distribution assembly, particularly for products to be packaged, comprising elements for moving products to be wrapped by means of a film, along a feed line of an apparatus that is functionally associated with a dispenser of the film for wrapping the products. At least the end portion of the feed line is constituted by at least two end parts that are substantially functionally parallel and lead to respective compartments of the apparatus for providing the final configuration of the wrapping of the products. Each of the end parts comprises at least one launcher for organizing the flow of products according to preset sequences, on each of the end parts.

The present invention relates to a movement and distribution assembly, particularly for products to be packaged.

### BACKGROUND OF THE INVENTION

In the field of automatic machines there are many machines capable of packaging products, adapting to extremely heterogeneous technical problems and formats.

Among these, automatic machines are known which offer the possibility to coat a predefined number of rolls of paper or the like by means of a film of polymeric material. The result obtained is thus a pack in which typically the rolls are arranged on multiple rows and optionally multiple layers, in the configuration in which they are proposed to the end consumer, in shops or shopping centers.

These machines are provided with a first series of launchers/dosage devices, which are fed by a conveyor belt that receives the rolls from a suitable buffer storage unit and sends them to a first traction device. Sending occurs according to preset sequences, with a spacing that the movement means that act in the subsequent steps must be able to maintain.

Among machines capable of providing a package with multiple layers of product, the most widespread have at least one portion of such first traction device that is capable of oscillating; more specifically, the portion arranged on the opposite side with respect to the launchers/dosage elements is the one that oscillates. The oscillation thus allows to obtain distribution of the rolls on two or more levels of a second traction device arranged downstream of the first device, if this is required by the type of product.

Finally, the second traction device delivers the groups of rolls to the apparatuses that actually wrap them by means of the film.

It is evident from the provided description that most of the assemblies responsible for traction of the rolls must be able to ensure that a given spacing is maintained. Two successive groups of rolls must in fact be spaced, in order to ensure delivery of a single group of rolls for each operating cycle of the machine.

More specifically, in order to allow delivery on multiple superimposed planes and at the same time maintain spaced advancement, it is necessary to resort to an apparatus for sorting on multiple planes: this may be, for example, an apparatus with a pendulum-like motion, such as the first traction device described. The structure of such a device poses several problems and its alternating mode of operation, with very high cycles, limits the performance of the machine if the provision of a package with multiple layers is required.

This is in fact an apparatus that is subjected to intense mechanical stresses, since it must ensure, in the desired wrapping cycle time, a multiple delivery (one for each plane). Multiple delivery imposes high-speed operation to the bars of the first traction device, which provide the movement; the oscillating elements are instead subjected to continuous and violent accelerations and decelerations.

Since it is further necessary to transfer the groups of rolls from one traction device to the other, and since it is necessary to ensure the passage of the bars of each of the two devices, the rolls must move beyond a part in which they are not supported in a lower region. The consequent risk is that the group of rolls may become untidy, causing problems for subsequent packaging.

Further, again due to the discontinuity of transport caused by transition between a first traction device and a second traction device, the rolls delivered by the first device stop by friction on the sliding surface of the second device, waiting for the arrival of the bars of such second device; when such bars arrive, a violent impact occurs against the bottom of the rolls, which at this point are stationary, and can cause the breakup of the group of rolls.

Finally, it should be noted that the presence of two different types of traction device forces the use of a wide variety of mutually different components, which inevitably generate substantial management and logistic cost problems.

### SUMMARY OF THE INVENTION

The aim of the present invention is to solve the above-mentioned drawbacks, by providing a movement and distribution assembly in which the spaced delivery of the products to the subsequent devices assigned to packaging does not prevent the possibility of a structurally simple embodiment.

Within this aim, an object of the invention is to provide a movement and distribution assembly in which the layered delivery of the products to the subsequent devices assigned to packaging occurs with a high performance.

Another object of the invention is to provide a movement and distribution assembly that ensures correct movement of the products, limiting to a minimum deteriorations of the quality of the produced packages and the operating problems caused by incorrect handling.

A further object of the invention is to provide a movement and distribution assembly that ensures high reliability in operation.

Another object of the invention is to provide a movement and distribution assembly that can be obtained easily starting from commonly commercially available elements and materials.

Another object of the invention is to provide a movement and distribution assembly that has a low cost, is relatively simple to provide in practice and is safe in application.

This aim and these and other objects, which will become better apparent hereinafter, are achieved by a movement and distribution assembly, particularly for products to be packaged, which comprises means for moving products to be wrapped by means of a film, along a feed line of an apparatus that is functionally associated with a dispenser of the film for wrapping the products, at least the end portion of said line being constituted by at least two end parts that are substantially functionally parallel and lead to respective compartments of the apparatus for providing the final configuration of the wrapping of products, characterized in that each of said end parts comprises at least one launcher for organizing the flow of products according to preset sequences, on each of said final parts.

### BRIEF DESCRIPTION OF THE DRAWINGS

Further characteristics and advantages of the invention will become better apparent from the following detailed description of a preferred but not exclusive embodiment of the movement and distribution assembly according to the invention, illustrated by way of non-limiting example in the accompanying drawings, wherein:

FIG. 1 is a schematic side elevation view of the movement and distribution assembly according to the invention;

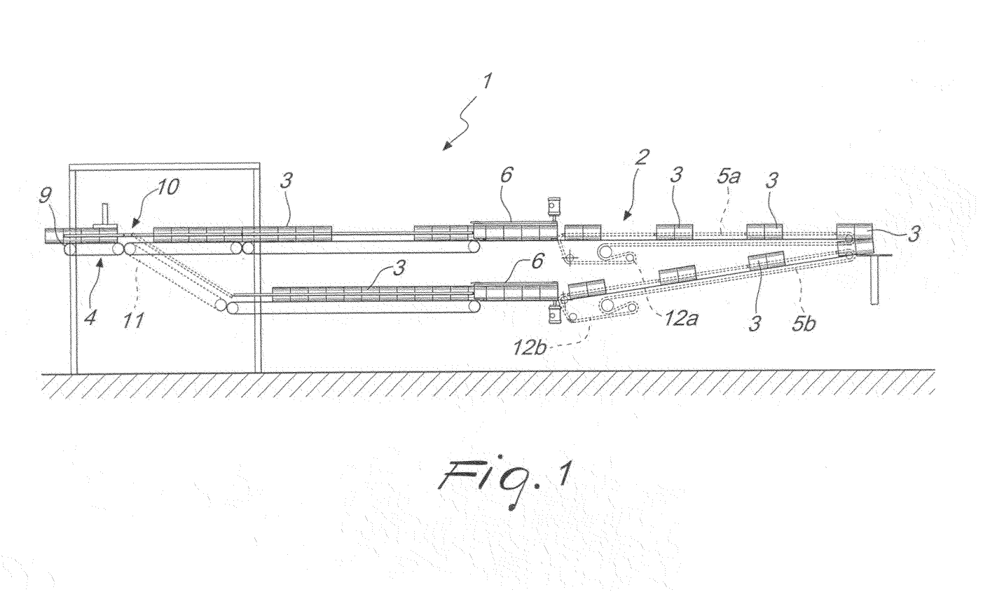

FIG. 2 is a plan view of an end portion of the movement and distribution assembly shown in FIG. 1.

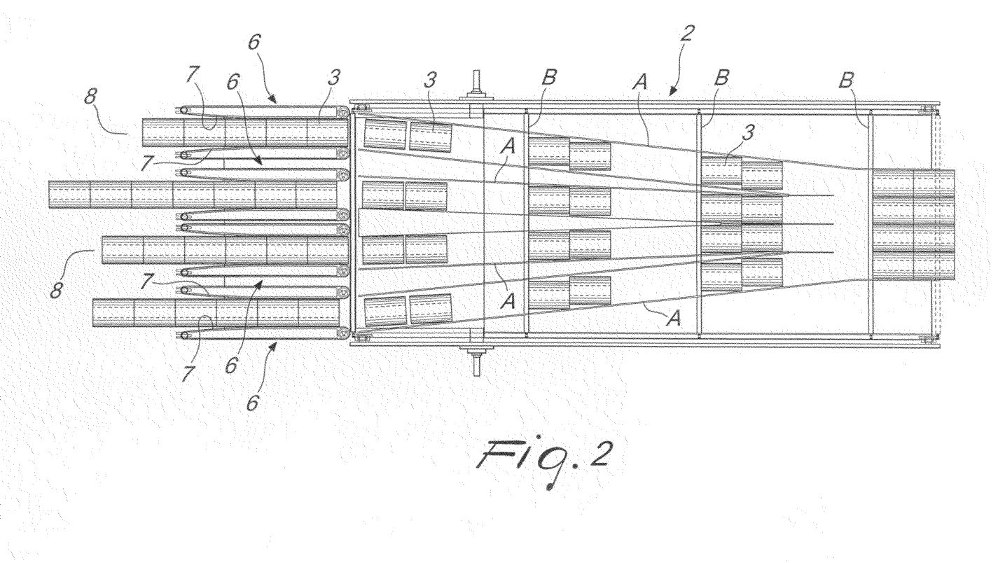

### DESCRIPTION OF THE PREFERRED EMBODIMENTS

With reference to the figures, a movement and distribution assembly according to the invention, generally designated by the reference numeral 1, comprises movement means 2 for products 3 that must be subsequently wrapped by a film. The movement means 2 act along a feed line 4 of an apparatus which is functionally associated with a film dispenser, with which the desired wrapping of the products 3 is to be performed.

In particular, according to a possible embodiment of particular interest in practice which however does not limit the scope of the invention, the products 3 can have a substantially tubular shape and can be constituted by a continuous wrapping of paper on a cylindrical cardboard core; the paper can be of the so-called “tissue” type, such as toilet paper or kitchen paper.

At least the end portion of the feed line 4 is constituted by at least two end parts 5a, 5b, which are arranged in a substantially parallel functional arrangement. This arrangement allows the delivery of the products 3 to respective compartments of the apparatus, which provide, by wrapping the film on the products 3, the desired final configuration.

According to the invention, each one of the end parts 5a, 5b comprises at least one launcher 6 for organizing the flow of products 3 along the feed line 4 on each of the end parts 5a, 5b downstream of the launcher 6 according to preset sequences.

More particularly, the feed line 4 comprises at least two end parts 5a, 5b, which are arranged in a functionally parallel arrangement and are substantially superimposed, in order to deliver the products 3 to compartments which in turn are superimposed, thus providing the configurations with superimposed layers of products 3 according to the formats that can be found in shops and shopping centers.

In order to allow the definition of a final configuration of products 3 that is constituted not only by two or more layers but also by two or more of rows, each of the end parts 5a, 5b comprises a plurality of mutually laterally adjacent guiding channels A. Each guiding channel A is capable of allowing a unit flow of products 3 and is associated with one respective launcher 6. Each guiding channel A therefore leads to a corresponding compartment, obtaining at each operating cycle the desired number of products 3 in the desired configuration.

Conveniently, each launcher 6 comprises two belts 7, which face each other in order to form a passage duct 8 for the products 3. The belts 7 turn at a predefined speed in order to allow the traction, dosage and sending of the products 3 to the subsequent portions of the end parts 5a, 5b according to the desired preset sequences.

In particular, the passage duct 8 can have in a first part a converging cross-section, in order to recover any spreading of the products 3 that has occurred upstream and allow the accumulation of the products 3, which arrive at a speed that is higher than, or equal to, the packaging speed of the products 3 in the machine. In the subsequent portion of the passage duct 8, the belts 7 take delivery of the products 3, clamping them laterally, and then launch them to the subsequent portions of the end parts 5a, 5b, at the desired rate, defined by the speed of the belts 7.

Advantageously, the feed line 4 comprises upstream of the end parts 5a, 5b a first part 9, which is fed by a product magazine 3. The first part 9 leads to a redirection device 10, which can be actuated on command in order to divert the flow of products 3 from one of the end parts 5a, 5b to the other one and vice versa.

More particularly, according to a possible embodiment, downstream of the first part 9 the supply line 4 comprises a bifurcation 11, which connects it to both end parts 5a, 5b. The redirection device 10 comprises baffles and buffers, which can be actuated on command to prevent the advancement of products 3 toward one of the end parts 5a, 5b and divert their flow on to the other one and vice versa.

In order to ensure that the spacing provided by the launchers 6 is maintained, the movement means 2 comprise support and traction units 12a, 12b, for example belts or chains, for a plurality of bars B. The bars B are spaced according to such spacing and are capable of drawing the products 3 along the portion of the end parts 5a, 5b that is arranged downstream of the launchers 6. The support and traction units 12a, 12b are functionally associated with the portions of the end parts 5a, 5b indicated above, particularly according to the embodiment that provides for the use of belts or chains.

It should be noted that only the portions of the end parts 5a, 5b that are arranged downstream of the launchers 6 must ensures spaced movement: this allows a simpler embodiment for the remaining portion of the end parts 5a, 5b and for the first part 9.

The operation of the movement and distribution assembly according to the invention is as follows.

The presence of a launcher 6 on each final part 5a, 5b, and more precisely on each guiding channel A, allows to space the flow of products 3. The products 3 are then moved by the supporting and traction units 12a, 12b to be fed to the compartments of the apparatus, in which they are wrapped by the film according to the desired final configuration.

The components of the assembly 1 according to the invention that are responsible for moving the products 3 arranged upstream of the launchers 6 can thus be provided in manners that are less complicated from a structural standpoint, since they are not required to comply with the speed of the flow of products 3.

In particular, the assembly 1 according to the invention allows to provide the desired stratification by means of a redirection device 10, which is constituted by suitable baffles and buffers, which provide redirection with the cycle required for correct feeding of the launching units; further, it should be noted that the portion of the end parts 5a, 5b that is interposed between the redirection device 10 and the launchers 6 can be used, if sized appropriately, as a useful buffer for accumulating products 3. This in fact allows to reduce drastically the performance required of the redirection device 10, since it is possible to launch a large number of products 3 on each layer before operating the redirection device 10 to divert the flow onto another one. The elements that are responsible for redirection, such as baffles or buffers, can thus be sized and designed to work at reduced speeds, so as to not stress them excessively.

Further, in the assembly 1 it can be noted easily that the correct treatment of the products 3, and therefore the assurance of the absence of dangers of deterioration of packaging quality is ensured by the lack of jumps or discontinuities along the feed line 4 downstream of the launchers 6.

Finally, it should be noted that both the launchers 6 and the end parts 5a, 5b can be very similar to each other, thus allowing to resort to the same materials and to reduce usefully the number of different components to be supplied.

In practice it has been shown that the movement and distribution assembly 1 according to the invention fully achieves the proposed aim, since the presence of one launcher 6 along each final part 5a, 5b allows to simplify the structure of the components assigned to the movement of the products 3 arranged upstream of the launchers 6, and in particular as regards the elements assigned to the stratification of flow.

The invention thus conceived is susceptible of numerous modifications and variations, all of which are within the scope of the appended claims; further, all the details may be replaced with other technically equivalent ones.

Moreover, it is noted that anything found to be already known during the patenting process is understood not to be claimed and to be the subject of a disclaimer.

In practice, the materials used, as well as the dimensions, may be any according to requirements and to the state of the art.

The disclosures in Italian Patent Application No. BO2007A000733 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-7. (canceled)

8. A movement and distribution assembly, particularly for products to be packaged, comprising means for moving products to be wrapped by means of a film, along a feed line of an apparatus that is functionally associated with a dispenser of the film for wrapping the products, at least the end portion of said feed line being constituted by at least two end parts that are substantially functionally parallel and lead to respective compartments of the apparatus for providing the final configuration of the wrapping of products, wherein each of said end parts comprises at least one launcher for organizing the flow of products according to preset sequences, on each of said end parts.

9. The movement and distribution assembly according to claim 8, wherein said feed line comprises at least two end parts, which are substantially functionally parallel and substantially superimposed in order to stratify the products.

10. The movement and distribution assembly according to claim 9, wherein each of said end parts comprises a plurality of guiding channels for a unitary flow of products arranged mutually side-by-side, each of said guiding channels being functionally associated with a respective launcher, each of said guiding channels leading to a corresponding compartment of the apparatus, for stratification in multiple rows of products.

11. The movement and distribution assembly according to claim 10, wherein each of said launchers comprises two belts that face each other in order to form a passage duct for the product, said belts being movable at a predefined speed for traction, dosage and sending of the products to said end parts, according to preset sequences.

12. The movement and distribution assembly according to claim 8, wherein said feed line comprises, upstream of said end parts, a first part, which is fed by a magazine for products, for feeding to a redirection device, which can be actuated on command in order to redirect the flow of products from one of said end parts to the other one of said end parts and vice versa.

13. The movement and distribution assembly according to claim 12, comprising, downstream of said first part, a bifurcation for connecting said first part to said end parts, said redirection device comprising baffles that can be actuated on command in order to prevent the advancement of the products toward one of said end parts and divert the flow onto the other one, and vice versa.

14. The movement and distribution assembly according to claim 8, wherein said movement means comprise support and traction units for a plurality of bars, which are spaced with a set spacing, for drawing the products, each of said end parts being functionally associated with one of said units.
